(19) United States
(12) Patent Application Publication
(10) Pub. No.: US 2010/0271443 A1
(43) Pub. Date: Oct. 28, 2010

(54) INK CARTRIDGE HAVING A PRISM

(76) Inventors: Lori Nelson, Vancouver, WA (US); Steven H. Walker, Camas, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/739,238

(22) PCT Filed: Dec. 6, 2007
(86) PCT No.: PCT/US07/86570

§ 371 Date: Apr. 22, 2010

(51) Int. Cl. B41J 2/175

(52) U.S. Cl. 347/86

(57) ABSTRACT

In one embodiment an ink cartridge includes: a housing defining an ink holding chamber; and a molded plastic prism having a light reflecting surface exposed to an interior of the ink holding chamber, a cavity therein for relieving strain in the prism as the prism cools from molding, and a textured surface defining one wall of the cavity. In another embodiment, an ink cartridge includes: an ink holding chamber; and a prism having: a base through which light may enter the prism; a reflecting surface exposed to an interior of the ink holding chamber, the reflecting surface oriented relative to the base such that light entering the prism through the base is reflected off the reflecting surface at varying levels depending on a refractive index of an environmental medium surrounding the reflecting surface; and a cavity having a light-scattering surface therein.

### BACKGROUND

Reflective sensors use a prism to direct a beam of light from the sensor's light source/emitter to the sensor's light detector. Reflective sensors are often used in ink cartridges to sense the level of ink in the cartridge. The accuracy of reflective sensors is dependent, in part, on the quality of the surfaces of the prism. Prisms used for ink level sensors are usually molded plastic parts that utilize a cavity, commonly referred to as a “core-out”, to relieve strain as the part cools. The core-out cavity keeps the cross sectional area of the part more constant, allowing the part to cool more uniformly and reduce the differential strain that causes sink/concavity in the optical surfaces. Under certain circumstances, however, light from a sensor's emitter may be reflected off the ceiling of the core-out cavity. For example, it may be desirable as a means for reducing cost and increasing yield to expand allowable molding tolerances for the prism and to expand the emission profile of the light emitter and light detector. These expansions, however, increase the risk of introducing sink in the prism surfaces, including the ceiling of the core-out cavity. Light from the emitter striking a curved (sunk/concave) ceiling of the core-out cavity, instead of striking a flat surface, is more likely to be reflected back to the detector, resulting in an incorrect signal for ink level.

### DRAWINGS

FIG. 1 is a perspective view of an ink cartridge according to one embodiment of the disclosure.

FIG. 2 is a side elevation view of the ink cartridge of FIG. 1.

FIG. 3 is a section view taken along the line 3-3 in FIG. 2.

FIG. 4 is a section view illustrating a light ray path tracing for a high ink level in the cartridge of FIGS. 1-3.

FIG. 5 is a section view illustrating a light ray path tracing for a low ink level in the cartridge of FIGS. 1-3.

FIG. 6 is a perspective view of a prism according to one embodiment of the disclosure such as might be used in the ink cartridge of FIGS. 1-3.

FIG. 7 is a section view illustrating light reflected from a textured prism surface in an ink cartridge.

FIG. 8 is a section view illustrating a light ray path reflected from a non-textured prism surface in an ink cartridge.

### DESCRIPTION

Embodiments of the present disclosure were developed in an effort to reduce unwanted reflections from the core-out cavity ceiling in the prisms used in ink level sensors in ink cartridges. Exemplary embodiments of the disclosure will be described, therefore, with reference to prisms used in ink cartridges. Embodiments of the disclosure, however, are not limited to the exemplary embodiments shown and described below. Other forms, details, and embodiments may be made and implemented. Hence, the following description should not be construed to limit the scope of the disclosure, which is defined in the claims that follow the description.

As used in this document: “capillary ink” means ink held in an ink holding material suitable for generating capillary forces within the material, for example near an outlet from an ink holding chamber; a “chip” means an integrated or other electronic circuit that may be used to store information; “free ink” means ink free of any ink holding material; a “prism” means a substantially transparent body that is bounded in part by one or more planar faces used to reflect, refract and/or disperse light rays.

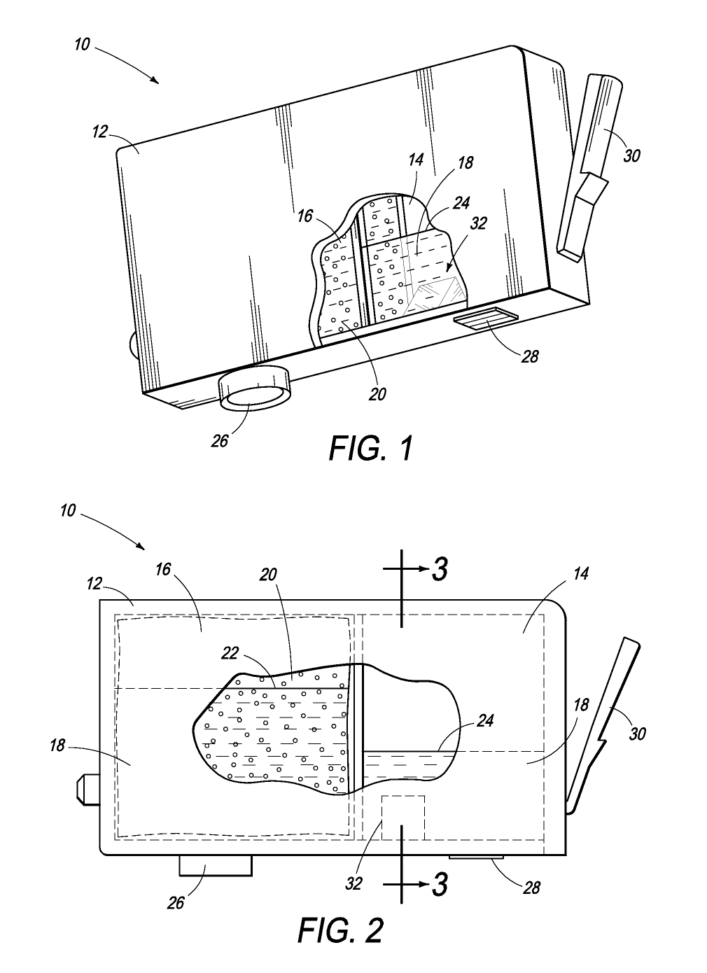

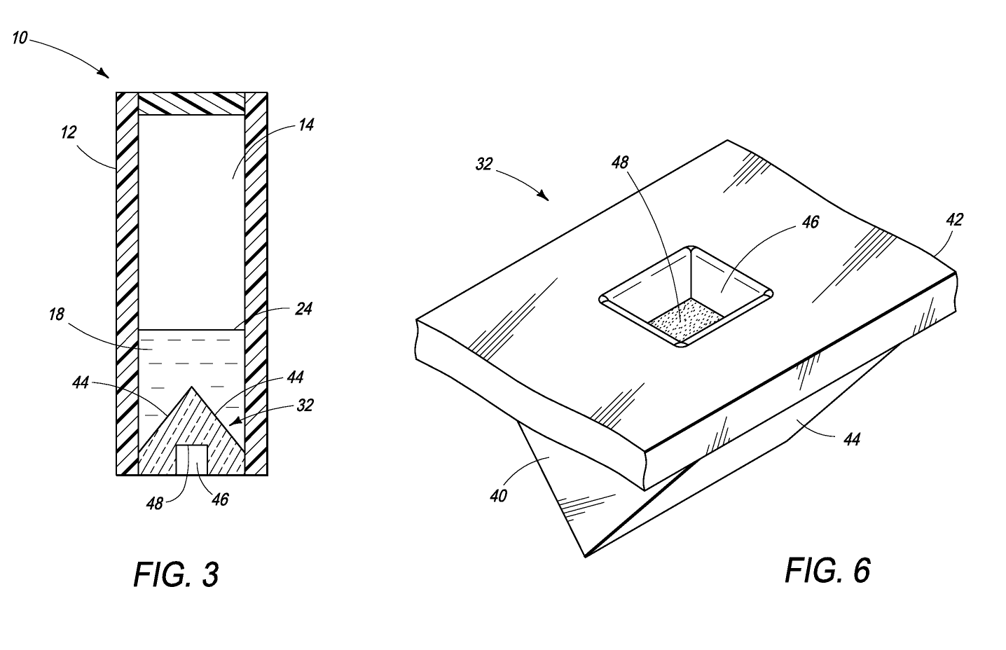

FIG. 1 is a perspective view of an ink cartridge 10 constructed according to one embodiment of the disclosure. FIG. 2 is a side elevation view of ink cartridge 10 and FIG. 3 is a section in view of ink cartridge 10 taken along the line 3-3 in FIG. 2. Referring to FIGS. 1-3, cartridge 10 includes a housing 12 that forms two internal chambers 14 and 16 for holding ink 18. Ink 18 is held freely in a free ink chamber 14. Ink 18 is held in a foam block 20 or other suitable ink holding material in a capillary chamber 16. Part number 22 (FIG. 2) designates the ink level in capillary chamber 16. Part number 24 designates the ink level in free ink chamber 14. Ink 18 may flow from cartridge 10 to a printhead or other downstream component in a printer through an outlet 26 from capillary chamber 16. Outlet 26 is also sometimes referred to as a fluid interface or fluid interconnect. As ink is withdrawn from capillary chamber 16 through outlet 26, the capillary action of foam 20 draws in ink from free ink chamber 14. Thus, the ink level 24 in free ink chamber 14 tends to be lower than the ink level 22 in capillary chamber 16 as ink is depleted from cartridge 10.

A chip 28 affixed to housing 12 is connected to the printer controller through a set of electrical contacts on the cartridge holder when cartridge 10 is installed in a printer. Chip 28 typically contains information that may be read and used by the printer controller in the operation of the printer including, for example, the status of the cartridge (e.g., new or used), the amount of ink remaining in the cartridge, the color of the ink, or the type of ink. A latch lever 30 helps secure cartridge 10 in, and release cartridge 10 from, a carriage or other holder on the printer.

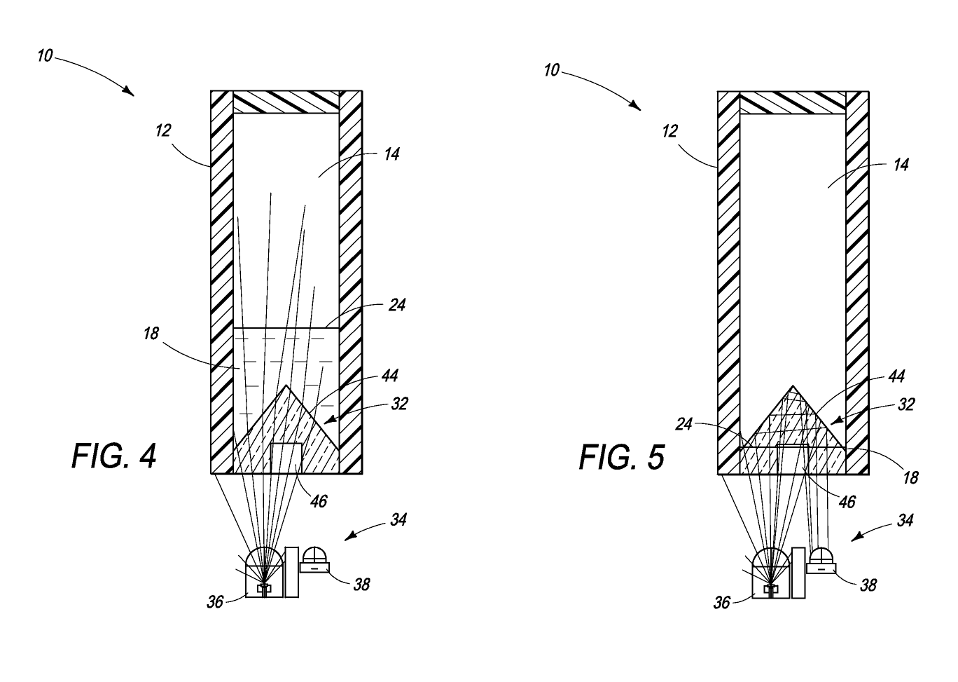

Cartridge 10 also includes a prism 32 which, in the embodiment shown, is located at the bottom of free ink chamber 14. Prism 32 is part of a sensing system 34 (FIGS. 4-5 and 7-8) used to sense the level of ink 18 in free ink chamber 14. FIG. 4 illustrates a light ray path tracing for a high ink level 24 in chamber 14. FIG. 5 illustrates a light ray path tracing for a low ink level 24 in chamber 14. Referring to FIGS. 4 and 5, sensing system 34 (or simply sensor 34) includes a light emitter 36, prism 32, and a light detector 38. Prism 32 may be characterized by a body 40, a base 42 that, in the embodiment shown, is integral to cartridge housing 12, and reflecting surfaces 44 that intersect base 42 at an acute angle. Light from emitter 36 enters the body 40 of prism 32 through its base 42 and is reflected off reflecting surfaces 44 at varying levels depending on the refractive index of the environmental medium surrounding reflecting surfaces 44. When reflecting surfaces 44 are submerged in ink 18, as shown in FIG. 4, little if any light is reflected internally off surfaces 44 back to detector 38 and detector 38 detects a lower signal. When reflecting surfaces 44 are exposed to air, as shown in FIG. 5, much of the light from emitter 36 is reflected internally off surfaces 44 and detector 38 detects more light. The difference between the index of refraction of ink 18 in chamber 14 and the index of refraction of air in chamber 14 determines the amount of light incident on surfaces 44 that is reflected back to detector 38. As the level of ink 18 in chamber 14 traverses down reflecting surfaces 44, more and more light is reflected back to detector 38.

FIG. 6 is a perspective detail view of prism 32. In FIG. 6, prism 32 is depicted “upside down” from its orientation in FIGS. 1-5 to better illustrate the specific features described below. A cavity 46 is formed in the body 40 of prism 32. Cavity 46 is open to prism base 42. That is to say, cavity 46 forms an opening in base 42 that extends into body 40. As noted above in the Background, cavity 46 is molded into prism 32 as a “core-out” to relieve strain as prism 32 cools from the molding process. Core-out cavity 46 keeps the cross sectional area of prism 32 more constant, allowing prism 32 to cool more uniformly and reduce the differential strain that causes sink/concavity in the optical surfaces, base 42 and reflecting surfaces 44. (Housing 12 may be molded as a single unit, including prism 32, or as two or more parts.) The ceiling 48 of cavity 46 is textured to reduce unwanted light reflections off ceiling 48. Ceiling 48 refers to the internal surface of cavity 46 that is generally parallel to the plane of prism base 42. This surface 48 typically will be located at the top of cavity 46, above base 42, when cartridge 10 is installed in a printer. Thus, it is convenient to refer to a cavity “ceiling” 48. The relative position of surface 48, of course, may vary depending on the actual orientation of prism 32 and cartridge 10 at any given time, or for any particular installation.

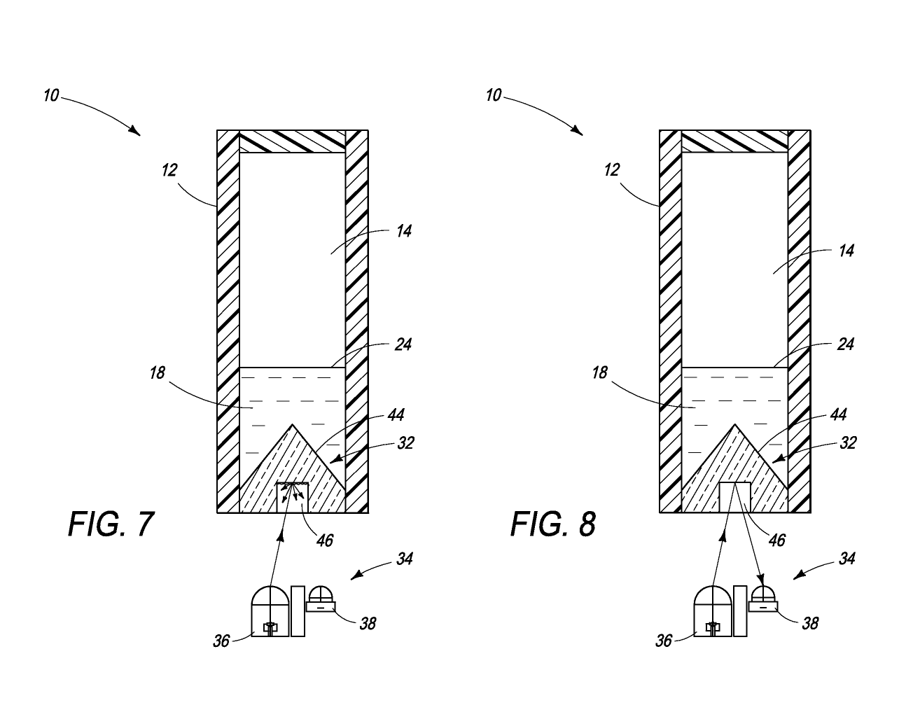

By texturing surface 48 in core-out cavity 46, unwanted light reflections may be reduced. When light from emitter 36 strikes textured cavity ceiling 48, the light strikes a multi-faceted surface instead of striking a smooth curved (sunk/concave) surface. Hence, most of the light is scattered incoherently, as shown in FIG. 7, rather than back to detector 38, as shown in FIG. 8. Any light which happens to be directed back to detector 38 from textured surface 48 has had the majority of its energy redirected and, therefore, is less likely to produce a false signal at detector 38. Some prisms that would otherwise have been rejected for inferior quality due to the sink/concavity in the core-out cavity surface 48 would now be acceptable. Ambient “ghost” light is also scattered by textured surface 48, increasing the functional robustness of ink level sensing. The ghost reflection captured as the orientation between prism 32 and detector 38 changes is minimized.

The height and pitch of the texture affects the extent to which light is scattered from surface 48. If the height is low or the pitch is large, or both, surface 48 begins to approximate a smooth surface, decreasing its ability to scatter light. If the height is high and the pitch is small, the texture begins to fill in cavity 46, reducing the effectiveness of cavity 46 as a strain reliever. In either case, height and pitch may be limited by the degree of precision available in the molding process. It has been observed that an SPI (Society of Plastics Industry) D3 Surface Finish mold texture on surface 48 provides suitable light scattering. A D3 texture is a common “pebble” type texture with little or no directionality, giving the appearance of a matte or diffuse surface. It is expected that a surface roughness in the range of 190-230 micro inches will provide suitable light scattering.

As noted at the beginning of this Description, the exemplary embodiments shown in the figures and described above illustrate but do not limit the disclosure. Other forms, details, and embodiments may be made and implemented. For example, the prism could be located in a capillary chamber, within a pocket in the ink holding material or within another free ink zone in the capillary chamber so that the ink holding material does not disrupt the reflecting characteristics of the prism surface(s). For another example, the prism may have only a single reflecting surface or more than two reflecting surfaces. The foregoing description, therefore, should not be construed to limit the scope of the disclosure, which is defined in the following claims.

What is claimed is:

1. An ink cartridge, comprising:
a housing defining an ink holding chamber; and
a molded plastic prism having a light reflecting surface exposed to an interior of the ink holding chamber, a cavity therein for relieving strain in the prism as the prism cools from molding, and a textured surface defining one wall of the cavity.

2. The ink cartridge of claim 1, wherein the textured surface comprises a light-scattering surface.

3. The ink cartridge of claim 1, wherein the textured surface comprises a textured surface having a surface roughness in the range of 190-230 micro inches.

4. The ink cartridge of claim 1, wherein the housing comprises a molded plastic housing and the prism is integral to the housing.

5. The ink cartridge of claim 1, wherein the light reflecting surface comprises a plurality of light reflecting surfaces exposed to an interior of the ink holding chamber.

6. The ink cartridge of claim 1, wherein the prism comprises a molded plastic body having a base through which light enters the prism and the light reflecting surface comprises a plurality of light reflecting surfaces intersecting the base, the body also having the cavity therein open to the base for relieving strain in the body as the body cools from molding, and the textured surface defining one wall of the cavity oriented generally parallel to a plane of the base such that light striking the textured surface scatters.

7. The ink cartridge of claim 6, wherein each reflective surface intersects the base at an acute angle.

8. An ink cartridge, comprising:
an ink holding chamber; and
a prism having: a base through which light may enter the prism; a reflecting surface exposed to an interior of the ink holding chamber, the reflecting surface oriented relative to the base such that light entering the prism through the base is reflected off the reflecting surface at varying levels depending on a refractive index of an environmental medium surrounding the reflecting surface; and a cavity having a light-scattering surface therein.

9. The ink cartridge of claim 8, wherein the base of the prism is integrated into one of a plurality of surfaces defining the ink holding chamber.

10. The ink cartridge of claim 9, wherein the base of the prism is integrated into a bottom surface of the ink holding chamber.

11. The ink cartridge of claim 8, wherein the ink holding chamber comprises a first ink holding chamber having an ink holding material therein and a second ink holding chamber in fluid communication with the first ink holding chamber, the second ink holding material not having an ink holding material therein, and the prism reflecting surface exposed to an interior of the second ink holding chamber.

12. The ink cartridge of claim 8, wherein the light-scattering surface in the cavity comprises a textured surface.

13. The ink cartridge of claim 8, wherein the light-scattering surface in the cavity is oriented parallel to a plane of the base.

14. The ink cartridge of claim 8, wherein the reflecting surface comprises a plurality of reflecting surfaces oriented relative to the base such that light entering the prism through the base is reflected off the reflecting surfaces back through the base at varying levels depending on a refractive index of an environmental medium surrounding the reflecting surfaces.

15. An ink cartridge, comprising:
a housing defining a capillary ink holding chamber, a free ink holding chamber in fluid communication with the capillary ink holding chamber, and an outlet from the capillary ink holding chamber; and
a prism having a base and a plurality of light reflecting surfaces intersecting the base, the prism positioned in one of the ink holding chambers such that the light reflecting surfaces are fully covered with ink when a level of ink in the ink holding chamber is above a threshold level and progressively uncovered as the level of ink in the chamber falls below the threshold level, the prism further having a cavity therein open to the base, the cavity defined at least in part by a light-scattering surface oriented generally parallel to a plane of the base.

16. The ink cartridge of claim 15, further comprising an ink holding material in the capillary ink holding chamber.

17. The ink cartridge of claim 15, wherein the prism is positioned in the free ink holding chamber.

18. The ink cartridge of claim 15, wherein the base of the prism is integral to the housing.

19. The ink cartridge of claim 17, wherein the base of the prism is integral to a part of the housing defining a bottom surface of the free ink holding chamber.
